(19) United States
(12) Patent Application Publication
(10) Pub. No.: US 2010/0172316 A1
(43) Pub. Date: Jul. 8, 2010

(54) RESOURCE ALLOCATION METHOD FOR ORTHOGONAL FREQUENCY DIVISION MULTIPLEXING ACCESS SYSTEM

(76) Inventors: Sung-Hyun Hwang, Suwon-city (KR); Myung-Sun Song, Daejeon-city (KR); Chang-Joo Kim, Daejeon-city (KR); Yun-Hee Kim, Gyeonggi-do (KR); Jae-Yun Won, Seoul (KR)

Correspondence Address: LADAS & PARRY LLP, 224 SOUTH MICHIGAN AVENUE, SUITE 1600, CHICAGO, IL, 60604, US

(21) Appl. No.: 12/303,577

(22) PCT Filed: Oct. 30, 2006
(86) PCT No.: PCT/KR06/04459

§ 371 Date: Dec. 5, 2008

(30) Foreign Application Priority Data
Jun. 5, 2006 (KR) 10-2006-0050475

(51) Int. Cl. H04W 72/04

(52) U.S. Cl. 370/330

(57) ABSTRACT

A resource allocation method for an orthogonal frequency division multiplexing access (OFDMA) system is provided. The resource allocation method includes dividing a frequency band occupied by a predetermined number of OFDM symbols into a plurality of subbands and determining the number of diversity subchannels, each of which comprises at least two time-frequency resources respectively included in different subbands, and the number of subband selective subchannels, which comprise time-frequency resources that are not included in the diversity subchannels; and generating the diversity subchannels and the subband selective subchannels according to the determined numbers and allocating a physical channel comprised of a generated subchannel to a user in a cell. Accordingly, diversity is enhanced without reducing the freedom of selection of a subband.

### TECHNICAL FIELD

The present invention relates to a resource allocation method for an orthogonal frequency division multiplexing access (OFDMA) system, and more particularly, to a method of constructing a physical channel in an OFDMA system.

### BACKGROUND ART

In OFDMA systems, a physical channel is usually constructed as follows. A set of time-frequency resources in a time slot including at least one orthogonal frequency division multiplexing (OFDM) symbol and used subcarriers for the OFDM symbol is shared by multiple users. To achieve the sharing of the resources, a method of constructing a physical channel for data transmission using different resources orthogonal to each other is used

A resource is a subcarrier for a single OFDM symbol.

FIGS. 1A and 1B illustrate conventional methods of constructing a physical channel in an OFDMA system using frequency diversity and subband selection, respectively.

FIG. 1A illustrates a technique disclosed in EP No. 01039683, entitled “Frequency Hopping Multiple Access with Multicarrier Signals”. Referring to FIG. 1A, there are six OF DM symbols 101 through 106 and each of the OFDM symbols 101 through 106 includes a plurality of used subcarriers in a frequency domain. Each rectangular box denoted by reference numeral 100 indicates a used subcarrier, i.e., a resource. A plurality of resource distributed in a time-frequency domain are used in a single diversity channel. Referring to FIG. 1A, there exist diversity channels 0 and 1 and boxes having the same pattern are resources belonging to the same diversity channel. In the conventional method illustrated in FIG. 1A, a plurality of physical channels, each of which includes subcarriers having a small channel correlation, i.e., subcarriers far apart from each other temporally and spatially for an OFDM symbol, are generated. In other words, a subcarrier having a small channel correlation in the frequency domain and frequency hopping is performed such that a different subcarrier is selected for each OFDM symbol, thereby obtaining frequency diversity.

FIG. 1B illustrates a method disclosed in PCT WO No. 02/058300, entitled “Multicarrier Communications with Time Division Multiplexing and Carrier Selective Loading”. FIG. 1B is diagramed in the same manner as FIG. 1A. In the method illustrated in FIG. 1B, used subcarriers are classified into subbands 130_1 through 130_N comprised of adjacent subcarriers. Next, an optimal subband for a user is selected from among subbands for the user based on channel state information such as an average signal-to-noise ratio (SNR) or a minimum SNR in each subband and a subband selective channel 0 or 1 is formed. In addition, transmission is performed in an adaptive modulation and coding mode corresponding to a channel state.

The method illustrated in FIG. 1A uses information about an average SNR of resources distributed throughout the frequency domain to select an adaptive modulation and coding mode, whereby the amount of feedback information is as small as that in a single carrier system. Due to the small amount of feedback information, channel change can be quickly and appropriately handled in the same feedback time domain. However, in the method, since an average time-frequency diversity in a time slot is obtained without complicate optimization, the fact that wireless channel characteristics for individual users are different in the frequency domain is not efficiently used.

The method illustrated in FIG. 1B uses the feature that since a frequency response of a wireless channel is different for individual users, the users' preference for a subband is different, thereby maximizing a transmission rate. In other words, in this method, an optimal subband and an adaptive modulation and coding mode corresponding to the optimal subband are selected for each user. However, since it is necessary to feedback identification of at least one subband having a good channel state and information about the channel state in the subband, the amount of feedback information is greater than that in the method using a diversity physical channel. Due to this characteristic, the method illustrated in FIG. 1B is suitable for fixed- or low-speed users with rare channel change. However, even for low-speed or low-mobility users, when a frequency selectivity is high, channel change occurs even in a subband and a difference in a representative value of a channel state is small among subbands. As a result, performance improvement achieved due to subband selection is not big. In this case, a feedback channel is unnecessarily used without effective performance improvement.

Meanwhile, in a mobile cellular environment in which mobility and wireless channel characteristics are different according to users, using a single resource allocation method illustrated in FIG. 1A or 1B decreases resource-use efficiency. In addition, since frequency selectivity of a channel is different according to a user's position in a fixed wireless channel environment, if a physical channel is constructed using only the method illustrated in FIG. 1B, users having high frequency selectivity waste a lot of resources on feedback of channel state information and cannot obtain big performance improvement notwithstanding the high complexity of a subband selection algorithm. For this reason, methods of simultaneously supporting a subband selective subchannel and a diversity channel have been suggested, as illustrated in FIGS. 2A and 2B. FIG. 2A illustrates a method disclosed in Amendment to TTA PG302 standard established on June 2004 for 2.3 GHz portable Internet standard-physical layer. In the method, a subband selective channel region 211 and a diversity channel region 212 are isolated from each other in the time domain. FIG. 2B illustrates a method disclosed in PCT WO No. 02/49385, entitled “Multicarrier Communications with Adaptive Cluster Configuration and Switching”. In the method illustrated in FIG. 2B, a subband selective channel region 222 and diversity channel regions 221 and 223 are Isolated from each other in the frequency domain.

Meanwhile, users experiencing wireless a channel characteristics such as large channel change in a time slot, i.e., large time and frequency selectivity need allocation of a diversity channel. Examples of such users may be users at a cell boundary distant from a base station or users having a large mobility. It is necessary to allocate more transmission power to those users than to users using the subband selection method in order to obtain desired performance. However, when a diversity channel is independently defined in the time domain as illustrated in FIG. 2A, transmission power that can be allocated to users having a poor channel state is limited, and therefore, a cell coverage or a user data transmission rate is also limited.

This problem can be overcome by defining a diversity channel and a subband selective channel in the frequency domain as illustrated in FIG. 2B. However, since a region in which a diversity channel is allocated is isolated from resources used for subband selection in the frequency domain, a diversity gain obtainable with the diversity channel is limited. Moreover, when the subband channel is formed, since a subband having an excellent channel state should be selected in frequencies except for a frequency corresponding to the diversity channel, the freedom of selection is also limited. In particular, a subband selective channel is suitable for users having a small channel change. If a subband having an excellent channel state is used as a diversity channel, the excellent channel state of the subband is not appropriately utilized. As a result, performance cannot be enhanced.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B illustrate conventional methods of constructing a physical channel in an orthogonal frequency division multiplexing access (OFDMA) system;

FIGS. 2A and 2B illustrate other conventional methods of constructing a physical channel in an OFDM system;

FIGS. 3A and 3B illustrate channel structures with respect to resource allocation according to an embodiment of the present invention;

FIG. 4 is a flowchart illustrating a resource allocation method for an OFDMA system according to an embodiment of the present invention;

FIG. 5 illustrates a signal-to-noise ratio (SNR) versus a frequency in a channel environment in which a user is placed in an OFDMA system;

FIG. 6 illustrates a channel structure according to an embodiment of present invention;

FIGS. 7A through 7D are graphs illustrating performance of resource allocation met hod according to an embodiment of the present invention;

FIGS. 8A through 8D illustrate channel structures used to obtain the graphs illustrated in FIGS. 7A through 7D.

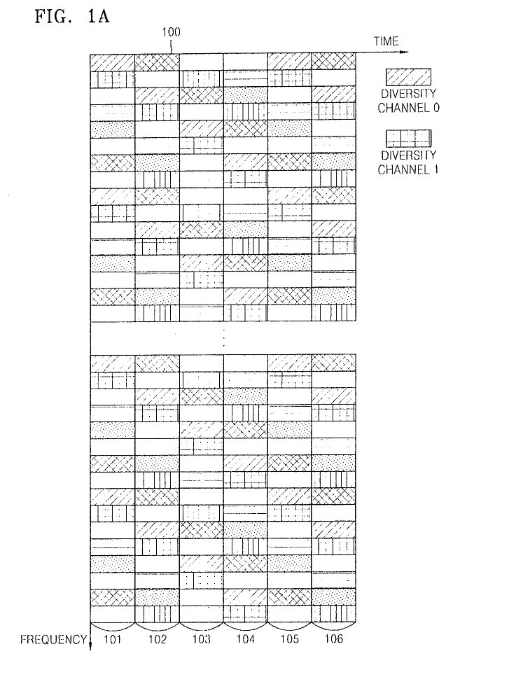

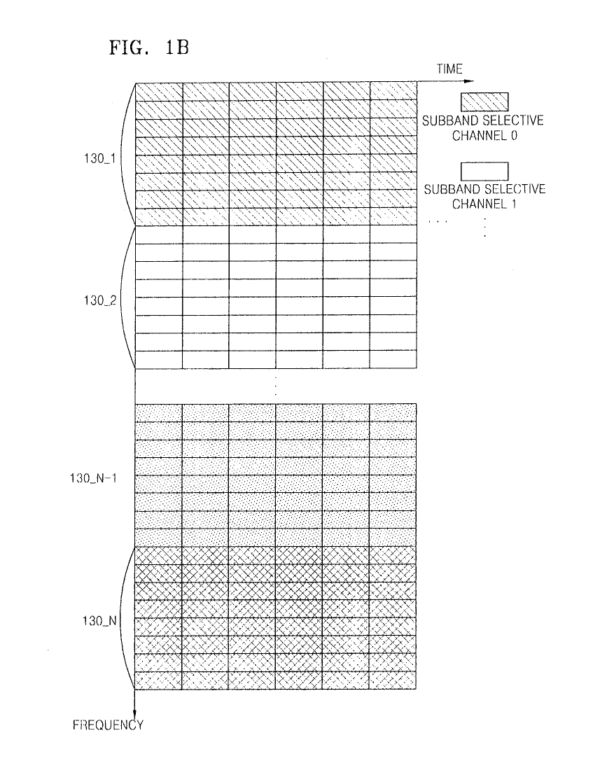

### DETAILED DESCRIPTION OF THE INVENTION

### Technical Problem

The present invention provides a resource allocation method for maximizing diversity without decreasing the freedom of selection of a subband in an orthogonal frequency division multiplexing access (OFDMA) system.

### Technical Solution

According to an aspect of the present invention, there is provided a resource allocation method for an OFDMA system. The resource allocation method includes dividing a frequency band occupied by a predetermined number of OFDM symbols into a plurality of subbands and determining the number of diversity subchannels, each of which comprises at least two time-frequency resources respectively included in different subbands, and the number of subband selective subchannels, which comprise time-frequency resources that are not included in the diversity subchannels; and generating the diversity subchannels and the subband selective subchannels according to the determined numbers and allocating a physical channel comprised of a generated subchannel to a user in a cell.

### Advantageous Effects

According to the present invention, when a subband having an excellent channel state is selected to allocate a physical channel to a particular user, a diversity physical channel can be allocated to another user with maximum diversity of the channel without reducing the freedom of subband selection. In addition, since the distribution ratio between subband selective physical channels and diversity physical channels is adaptively reconstructed according to the changes in active users in a cell and the changes in a wireless channel of each user, resource use efficiency is increased. Moreover, when a subband is selected for adaptive modulation and coding in a frequency domain, the diversity characteristic of a diversity physical channel is increased without reducing the number of candidate subbands.

### Mode for Invention

Hereinafter, preferred embodiments of the present invention will be described in detail with reference to the attached drawings. In the current specification, each of subcarriers for an orthogonal frequency division multiplexing (OFDM) symbol is referred to as a time-frequency resource or a resource. The present invention can be used to transmit control information and user data in a system using orthogonal frequency division multiplexing access (OFDMA). According to the present invention, a band of an OFDM symbol is divided into subbands each of which is a set of adjacent resources in a time-frequency domain. Next, resources are allocated to subband selective subchannels and to diversity subchannels such that a subband selective subchannel comprised of resources included in the same subband is orthogonal to a diversity subchannel comprised of resources evenly dispersed in different subbands. Next, a physical channel corresponding to a subband selective subchannel or a diversity subchannel suitable for a user is allocated based on a channel state. At this time, a subchannel is a minimum unit of a physical channel.

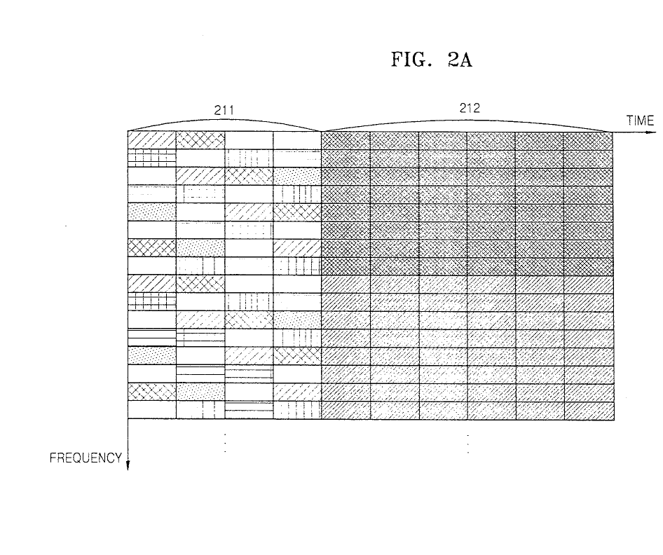

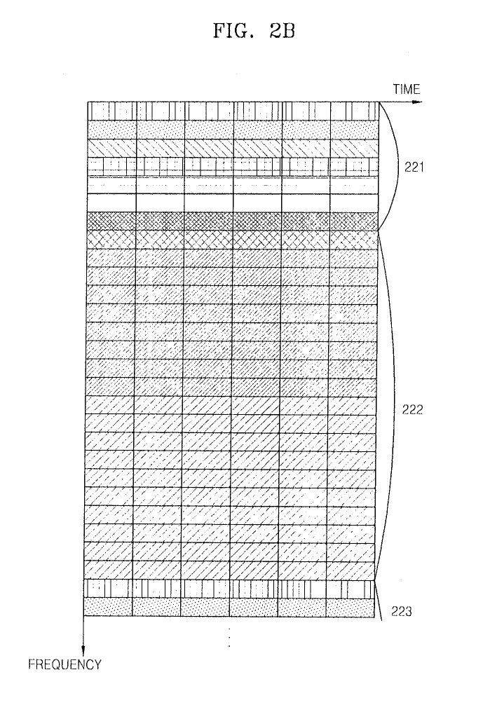

In particular, unlike the methods illustrated in FIGS. 2A and 2B, the present invention does not isolate a region for subband selective subchannels from a region for diversity subchannels in a time or frequency domain. In other words, in a channel structure according to the present invention, a region for subband selective subchannels and a region for diversity subchannels exist together in the time-frequency domain. As a result, when a subband having an excellent channel state is selected to allocate a physical channel to a user, a physical channel comprised of diversity subchannels can be allocated to another user with maximum use of diversity without decreasing the freedom of selection of a subband. In addition, when distribution of subband selective physical channels and diversity physical channels is reconstructed according to changes in active users within a cell and changes in the users' wireless channels, resource-use efficiency can be increased.

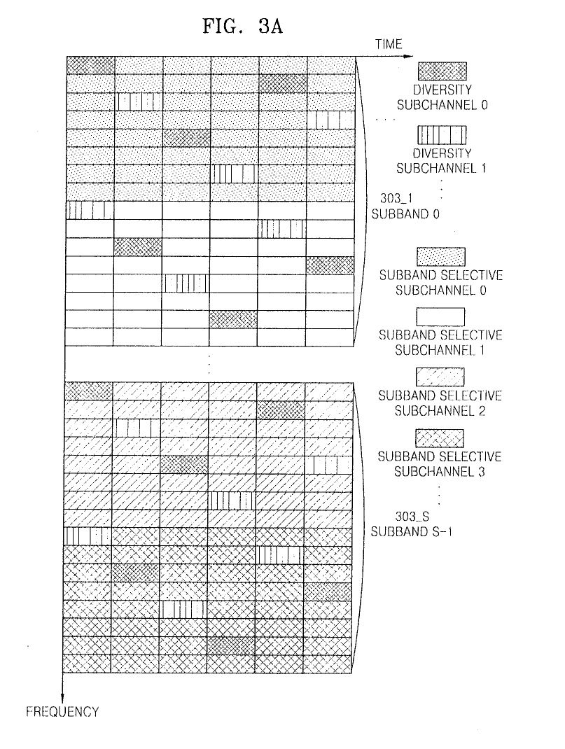

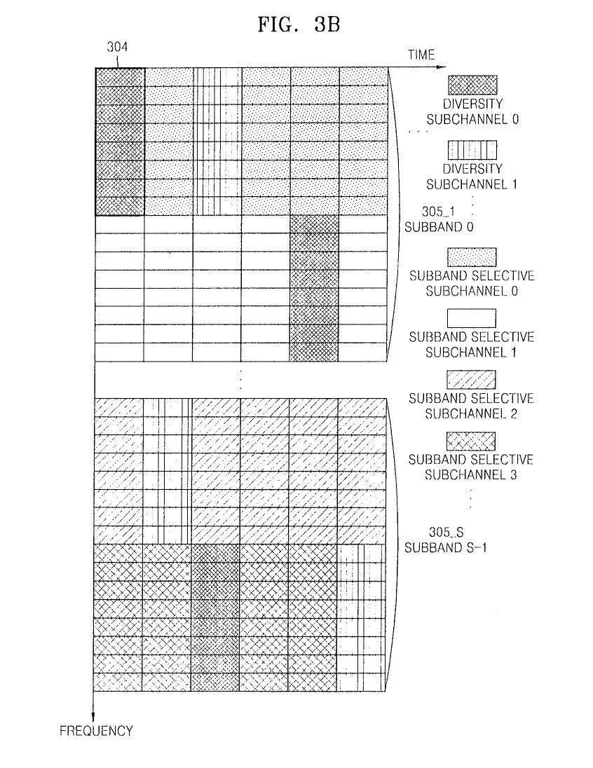

FIGS. 3A and 3B illustrate channel structures with respect to resource allocation ac cording to an embodiment of the present invention. In this specification, the iteration of a channel structure is referred to as a time slot. Referring to FIGS. 3A and 3B, six OFDM symbols construct a single time slot. In detail, a single resource is a minimum unit of a diversity subchannel in the structure illustrated in FIG. 3A while a plurality of adjacent resources form the minimum unit of the diversity subchannel in the structure illustrated in FIG. 3B.

Referring to FIG. 3A, time-frequency resources are classified into subbands 303_1 through 303_S in a frequency domain. Next, diversity subchannels 0 and 1 are formed using resources which are far apart from one another in terms of time and frequency in each of the subbands 303_1 through 303_S while subband selective subchannels 0, 1, 2, and 3 are formed using resources which are consecutive in terms of time and frequency in each of the subbands 303_1 through 303_S. Each of the subbands 303_1 through 303_S is a minimum unit used to transmit second channel state information when a subband selective physical channel is allocated. The second channel state information will be described in detail later.

In the present invention, a subband selective subchannel is formed using resources consecutive in terms of time and frequency, except resources allocated to a diversity sub channel.

Referring to FIG. 3B, a bin 304 may be a minimum unit of a subchannel. The bin 304 indicates a set of resources adjacent in terms of time or frequency. In other words, a diversity subchannel may be formed to include bins 304 in different subbands 305_1 through 305_S while a subband selective subchannel is formed to include at least one bin in the same band.

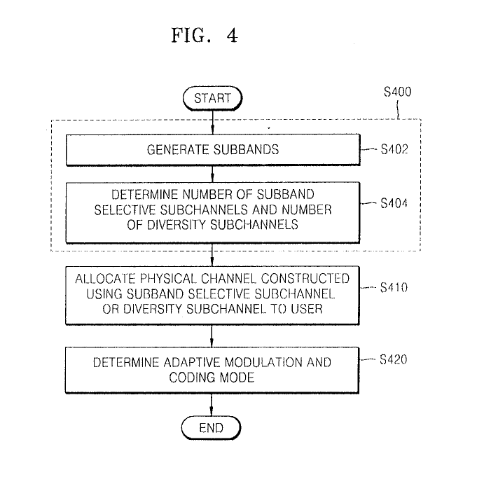

FIG. 4 is a flowchart illustrating a resource allocation method for an OFDMA system according to an embodiment of the present invention. In operation S400, a base station divides a frequency band occupied by a predetermined number of OFDM symbols into a plurality of subbands and determines the number of diversity subchannels, each of which includes at least two time-frequency resources included in different subbands, and the number of subband selective subchannels, which include time-frequency resources that are not included in the diversity subchannels. Each of the diversity subchannels may include at least two time-frequency resources respectively included in different OFDM symbols. The predetermined number of OFDM symbols indicates the number of OFDM symbols included in a time slot.

To determine the number of subchannels, users in a cell may be classified into a first user group, to which a physical channel constructed using a diversity subchannel is allocated, and a second user group, to which a physical channel constructed using a subband selective subchannel is allocated; and the number of diversity subchannels and the number of subband selective subchannels may be determined based on the first user group and the second user group. Alternatively, the number of diversity subchannels and the number of subband selective subchannels may be determined based on an available feedback channel capacity. As another alternative, the number of diversity subchannels and the number of subband selective subchannels may be determined based on determination on a ratio between the number of resources for the diversity subchannels and the number of resources for the subband selective subchannels.

The ratio between the number of resources for diversity subchannels and the number of resources for subband selective subchannels may be set to a particular value considering costs and complexity when a system is designed. Alternatively, a system may be designed to support a plurality of candidate ratios and one from among the candidate ratios may be selected according to users' wireless characteristics in a cell when a base station is installed. As another alternative, a base station may periodically monitor the wireless channel characteristics of active users in a cell, select an optimal resource ratio, and reconstruct a frame. The active users include users transmitting data at present and users about to transmit data soon. When the number of used subcarriers forming an OFDM symbol is represented with Nf and the number of resources forming a single subchannel is represented with RSch, the number of subchannels existing in a time slot including Nt OFDM symbols is expressed by ZT=NtNf/RSch. At this time, when the ratio of the number resources for diversity subchannels to the number of resources for subband selective subchannels is CD:CS, the number of diversity subchannels is ZD=ZTCD/(CD+CS) and the number of subband selective subchannels is ZS=ZT−ZD.

In an exemplary embodiment of forming a diversity subchannel, a subcarrier index of a k-th resource in an n-th OFDM symbol forming an i-th diversity subchannel (where i=0 , 1, . . . , ZD−1) is defined as Di(n,k)=αi(n)+kZT, where αi(n) is a subcarrier index offset with respect to the n-th OFDM symbol of the i-th diversity subchannel and indicates an index of a first subcarrier of the i-th diversity subchannel among subcarriers of the n-th OFDM symbol. Such a subcarrier index offset allows a diversity subchannel to be comprised of resources dispersed throughout the time-frequency domain. An example of the subcarrier index offset may be αi(n)=IZT/ZD+mod(n,ZT/(ZDNt)) so that the position of a subcarrier is different in each OFDM symbol.

Meanwhile, the number of OFDM symbols required to form a single subband selective subchannel may be different according to the ratio of CD:CS. For example, It is assumed that the number of resources forming a single subchannel is 48, i.e., RSch=48. At this time, if CD:CS=0:8, that is, no diversity subchannel is formed, a subband selective sub channel may be formed using eight adjacent subcarriers in a section occupied by six OFDM symbols. If CD:CS=2:6, a subband selective subchannel may be formed using resources in a resource block comprised of eight adjacent subcarriers in a section occupied by six OFDM symbols, except for sixteen resources included in diversity subchannels.

Operation S400 includes operation S402 and operation S404. In operation S402, the frequency band occupied by OFDM symbols is divided into a plurality of subbands. In operation S404, the number of diversity subchannels and the number of subband selective subchannels are determined. In detail, users in a cell are classified into the first user group and the second user group. The classification may be performed based on first channel state information of the users or the grade of each user ranked based on a use rate, but is not restricted thereto. An example of the first channel state information may be information about a rate of change of a wireless channel in the time or frequency domain. The information about the rate of change of a wireless channel may be selectivity information in the time-frequency domain.

Operation S404 will be described in detail by explaining a specific example below. A base station classifies active users into the first user group and the second user group based on the first channel state information of all users in a cell. Users having a low time selectivity and a low frequency selectivity are classified into the second user group and the remaining users are classified into the first user group. The users classified into the second user group may include users having a low frequency selectivity among users having no mobility or a low mobility and users placed in a fixed or low-speed mobile environment inside the cell. The user classified into the first user group may include users located far apart from the base station at the boundary of the cell and users having mobility. Alternatively, the classification of users may be performed based on users' grade information. In addition, the number of users in the second user group may be limited according to an available feedback channel capacity.

Specific examples of the first channel state information required for user classification or determination on the number of subchannels will be described below. Firstly, the first channel state information that includes frequency selectivity information of a wireless channel may be root mean square (RMS) delay spread. Secondly, the first channel state in formation that includes time selectivity information of a wireless channel may be a Doppler frequency of the wireless channel and a time variation of the wireless channel. Thirdly, the first channel state information that includes frequency selectivity information and time selectivity information of a wireless channel may be a normalized variance or a normalized standard deviation, which is calculated using channel power with respect to resources constructing a slot.

Firstly, the RMS delay spread is expressed by Equation (2) when the impulse response of a wireless channel is expressed by Equation (1).

$$h ( t , τ ) = {\sum }_{l = 0}^{M - 1} {α}_{l} ( t ) δ ( t - {τ}_{l} ) , \qquad ( 1 )$$

where αl(t) and τl denote a complex fading amplitude and a delay time, respectively, of an l-th path and M denotes the number of multiple paths.

$${τ}_{rms} = \sqrt{{\sum }_{l = 0}^{M - 1} {σ}_{l}^{2} {τ}_{l}^{2} - {( {\sum }_{l = 0}^{M - 1} {σ}_{l}^{2} {τ}_{l} )}^{2}} \qquad ( 2 )$$

To estimate the RMS delay spread of τrms, a multipath power density of σ₁² may be estimated with respect to each user's wireless channel and then the RMS delay spread may be calculated based on the estimated multipath power density. In other words, with respect to each user's wireless channel, σ₁²=E{α₁(t)²} and τl are estimated in a long-term and each user's RMS delay spread is calculated. Whether the channel frequency selectivity of the user is high or low is determined based on the calculated RMS delay spread. The base station is required to possess information about such RMS delay spread. The base station can possess the RMS delay spread information, when a terminal estimates an RMS delay spread using a pilot and a preamble according to the above-described met hod and periodically reports the estimated RMS delay spread to the base station or when the base station directly estimates an RMS delay spread using an uplink signal. The estimation using an uplink signal can be used in time division duplex (TDD) systems, in which channels have the same power density due to channel reciprocity, and can also be used in frequency division duplex (FDD) systems because an RMS delay spread characteristic of a channel is similar between an uplink and a downlink.

Secondly, the Doppler frequency of a wireless channel may be estimated by estimating an autocorrelation coefficient and the number of level crossings.

Thirdly, the normalized standard deviation may be estimated as follows. When a frequency response with respect to a k-th subcarrier of an n-th OFDM symbol in a time slot is represented with H(n,k), the frequency response of a channel is measured using a pre amble or a pilot transmitted from the base station and the mean and the variance of frequency response power in the time slot are obtained. The mean and the variance are expressed by Equations (3) and (4), respectively. Equation (5) expresses the normalized standard deviation of channel power. Since the normalized standard deviation indicates the amount of channel change in the time-frequency domain, the base station can allocate a channel using the normalized standard deviation.

$$\begin{matrix}Mean ( {\vert H \vert}^{2} ) = \frac{1}{{N}_{t} {N}_{f}} {\sum }_{n = 0}^{{N}_{t} - 1} {\sum }_{k = 0}^{{N}_{f} - 1} {\vert H ( n , k ) \vert}^{2} & ( 3 ) \\ Var ( {\vert H \vert}^{2} ) = \frac{1}{( {N}_{t} {N}_{f} - 1 )} {\sum }_{n = 0}^{{N}_{t} - 1} {\sum }_{k = 0}^{{N}_{l} - 1} {( {\vert H ( n , k ) \vert}^{2} - Mean ( {\vert H \vert}^{2} ) )}^{2} & ( 4 ) \\ NSTD ( {\vert H \vert}^{2} ) = \frac{\sqrt{Var ( {\vert H \vert}^{2} )}}{Mean ( {\vert H \vert}^{2} )} & ( 5 )\end{matrix}$$

In operation S410, the base station generates diversity subchannels and subband selective subchannels according to the determined numbers and allocates a physical channel constructed using the generated subchannels to a user in the cell.

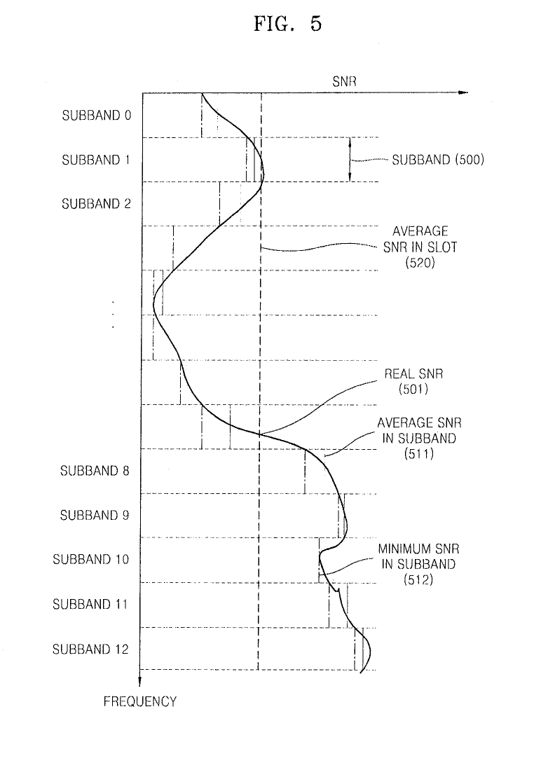

An embodiment of allocating the physical channel to a user included in the second user group will be described. The base station selects an active user to receive data in a frame from among the active users included in the second user group based on each user's second channel state information, the amount of data in the user's transmission data buffer, quality of services (QoS) of a transmission data packet, and the user's priority and fairness. At this time, the second channel state information is fed back from each user included in the second user group and may include identifiers of a predetermined number of subbands having a high average SNR and the average SNRs of the subbands. Next, the base station determines a subband selective subchannel used to construct a physical channel for the selected user based on the selected user's second channel state information, the amount of data in a transmission data buffer, QoS of a transmission data packet, priority, and fairness. For example, the base station may determine a subband selective subchannel advantageous to the selected user based on the second channel state information, which will be described in detail with reference to FIG. 5 later.

An embodiment of allocating the physical channel to a user included in the first user group will be described. The base station selects an active user to receive data in a frame from among the active users included in the first user group based on each user's second channel state information, the amount of data in the user's transmission data buffer, QoS of a transmission data packet, and the user's priority and fairness. At this time, the second channel state information is fed back from each user included in the first user group and may include an SNR value in an overall band. In addition, the normalized standard deviation may be included in the second channel state information in order to effectively allocate a diversity subchannel. Next, the base station allocates a diversity subchannel to the selected user according to the number of available subchannels for the user.

According to the current embodiment of the present invention, the second channel state information fed back from the first user group may be different from that feed back from the second user group for resource allocation and adaptive transmission.

In operation S420, the base station determines an adaptive modulation and coding mode for transmission for the user selected in operation S410, modulates and codes downlink data in the determined adaptive modulation and coding mode, and transmits the data to the user. A physical channel for a user included in the second user group may be constructed using subband selective subchannels existing in different subbands in operation S410. In this case, the adaptive modulation and coding mode may be different according to the subbands in which the subband selective subchannels are included. At this time, the adaptive modulation and coding mode indicates a transmission mode including modulation, channel coding, and a code rate.

FIG. 5 illustrates SNR characteristics and second channel state information in the frequency domain in a channel environment in which a user is placed in an OFDMA system. A feedback interval of the second channel state information used for resource allocation and adaptive transmission is different from a feedback interval of the first channel state in formation used for channel reconstruction. In detail, the feedback interval of the second channel state information may be a time comprised of a predetermined number of time slots or a frame time while the feedback interval of the first channel state information is usually much longer than the feedback interval of the second channel state information.

A user terminal included in the second user group obtains the second channel state information using a preamble or a pilot symbol included in a downlink signal and feeds the obtained second channel state information back to a base station. Referring to FIG. 5, the second channel state information may be an average 511 or a minimum 512 of a real SNR 501 in each subband 500 and a user terminal estimates the average 511 or the mini mum 512 of the real SNR 501 in each subband 500. When the transmission capacity of a feedback channel is limited, the user terminal compares SNRs among all subbands 500 and feeds an identifier of a subband 500 having the best SNR and a value of the best SNR back to the base station. When a user having a wireless channel illustrated in FIG. 5 can transmit channel state information of up to four subbands as the second channel state in formation, the second channel state information including subband identifiers 12, 11, 9, and 10 and SNR value information of these subbands is fed back to the base station.

A user terminal included in the first user group obtains the second channel state information using a preamble or a pilot symbol included in a downlink signal. Differently from the second channel state information of the second user group, the second channel state information of the first user group may be an average SNR 520 in an overall band, i.e., in a time slot.

As described above, the second channel state information is used to allocate subband selective subchannels to the second user group in operation S410 and also used to determine the adaptive modulation and coding mode for the first and second user groups in operation S420. It has been described that an average SNR is the second channel state in formation, but the second channel state information may additionally include the normalized standard deviation expressed by Equation (3) for more precise determination of the adaptive modulation and coding mode.

Meanwhile, the base station may repeat operation S400 with a predetermined period in order to reconstruct the number of subband selective subchannels and the number of diversity subchannels. At this time, the reconstruction result is reflected in operations S4 10 and S420. The predetermined period for reconstructing the subchannel ratio may be a duration corresponding to a frame length or several hundred-fold of the frame length. In particular, in order to reduce overhead used to transmit reconstruction information, the predetermined reconstruction period may be a duration corresponding to several-fold through several hundred-fold of the frame length. The base station broadcasts the reconstruct ion information regarding a physical channel to user terminals through a common cell control channel. At this time, a physical channel through which control information common to users in a cell or broadcast data information is transmitted may be constructed using a diversity subchannel.

A pilot symbol, which is transmitted for various purposes including channel estimation, may be transmitted through a diversity subchannel. In other words, a diversity subchannel may be allocated to a pilot channel in other embodiments of the present invention. In this case, all diversity subchannels except for the diversity subchannel allocated to the pilot channel are allocated to users in the first user group. The number of diversity subchannels allocated to the pilot channel may be set when a base station is installed or when a frame structure is reconstructed according to the first channel state information of users in a cell. Here, the base station also periodically broadcasts information about the reconstruction of the pilot channel to user terminals.

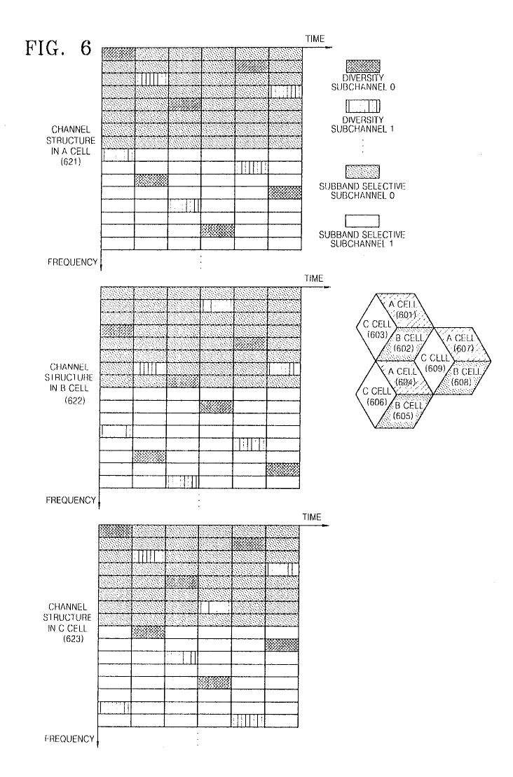

FIG. 6 illustrates a channel structure according to an embodiment of present invention. Referring to FIG. 6, channel structures 621, 622, and 623 are constructed such that A-cells 601, 604, and 607, B-cells 602, 605, and 608, and C-cells 603, 606, and 609 in A multi-cell environment have diversity subchannels which are comprised of different time-frequency resources. In other words, a diversity subchannel in a current cell does not include time-frequency resources included in a diversity subchannel in an adjacent cell. In particular, in the embodiment illustrated in FIG. 6, diversity channels in respective adjacent cells do not include the same time-frequency resources. In other words, a diversity subchannel in a cell may collide with a subband selective subchannel in another cell.

In this channel structure illustrated in FIG. 6, physical channels allocated to users at a cell boundary where a probability of allocation of a diversity subchannel is high do not collide with each other, so that interference experienced by the users at the cell boundary is reduced. This channel structure may be constructed by allowing a diversity subchannel to have a different start subcarrier index in a frame among individual cells.

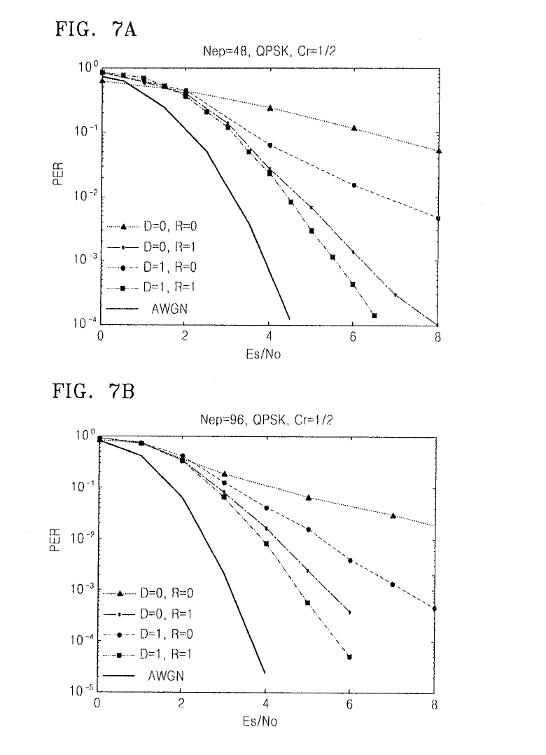

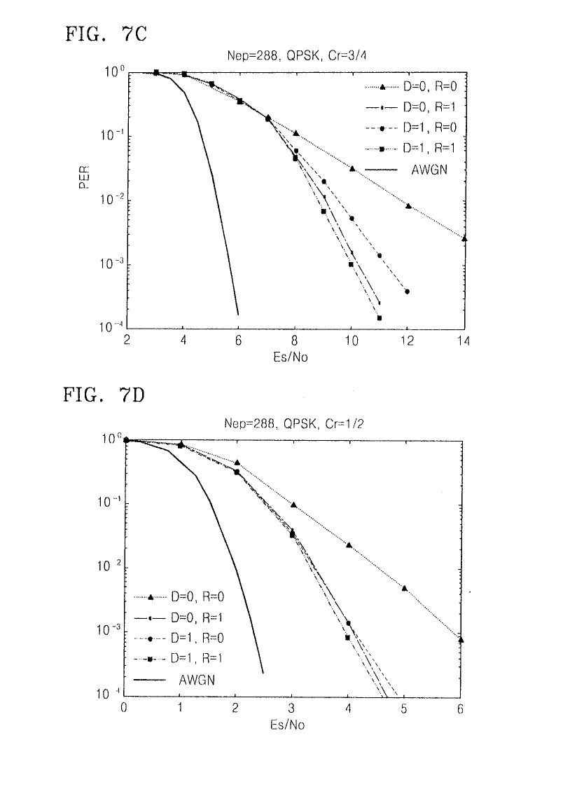

FIGS. 7A through 7D are graphs illustrating performance of resource allocation met hod according to an embodiment of the present invention. In the graphs, the horizontal axis indicates a symbol energy per noise power spectral density and the vertical axis indicates a packet error rate. In other words, FIGS. 7A through 7D illustrate performance obtained when transmission power was controlled at an average SNR in an environment in which a physical channel was constructed using a diversity subchannel. Referring to FIGS. 7 A through 7D, a fixed channel environment model was used, in which the number of multiple paths M=8 and the delay time τl=0, 3, 8, 11, 13, and 21 μs in Equation (1) and average powers of channel responses corresponding to the respective delay times were 0, −7, −15, −22, −24, and −19 dB. In addition, a sampling frequency was 10 MHz, an OFDM symbol was subjected to 2048 fast Fourier transform (FFT), and only Nf=1152 subcarriers were used among 2048 subcarriers included in the OFDM symbol. At this time, a used subcarrier had a bandwidth of about 6 MHz. Nt=6 OFDM symbols were included in a slot and a diversity subchannel was formed using RSch=48 resources dispersed in six OFDM symbols. Resources the number of which was an integer multiple of 48 were allocated to a single physical channel according to a coded input data size Nep and a code rate. A convolutional turbo code (CTC) was used as a channel code and quadrature phase shift keying (QPSk) was used as a modulation scheme.

Referring to FIG. 7A, the coded input data size is 48, the code rate is ½, and the number of subchannels per physical channel is 1. Referring to FIG. 7B, the coded input data size is 96, the code rate is ½, and the number of subchannels per physical channel is 2. Referring to FIG. 7C, the coded input data size is 288, the code rate is ¾, and the number of subchannels per physical channel is 4. Referring to FIG. 7D, the coded input data size is 288, the code rate is ½, and the number of subchannels per physical channel is 6.

In FIGS. 7A through 7D, when D=1, a minimum unit of a resource of a diversity sub channel is 1 as illustrated in FIG. 3A. When D=0, a bin comprised of 8 resources is used as illustrated in FIG. 3B. When R=1, an offset is set such that each OFDM symbol has a different subcarrier index. When R=0, the OFDM symbols have the same start subcarrier index for a diversity subchannel like αi(n)=constant.

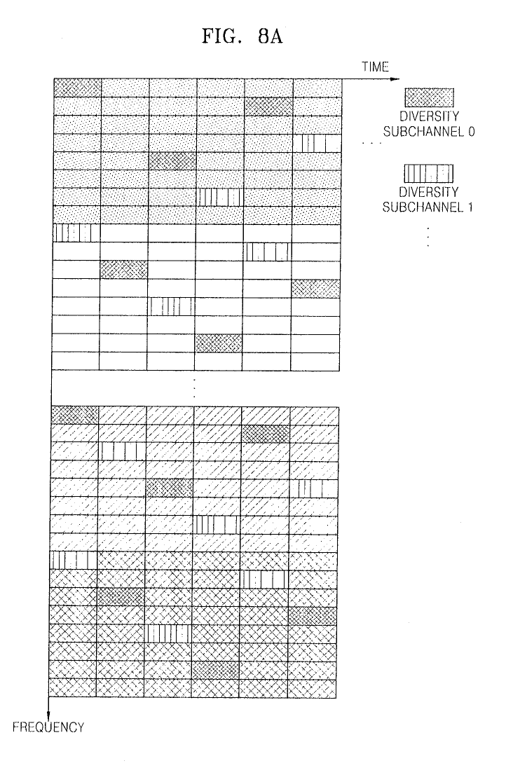

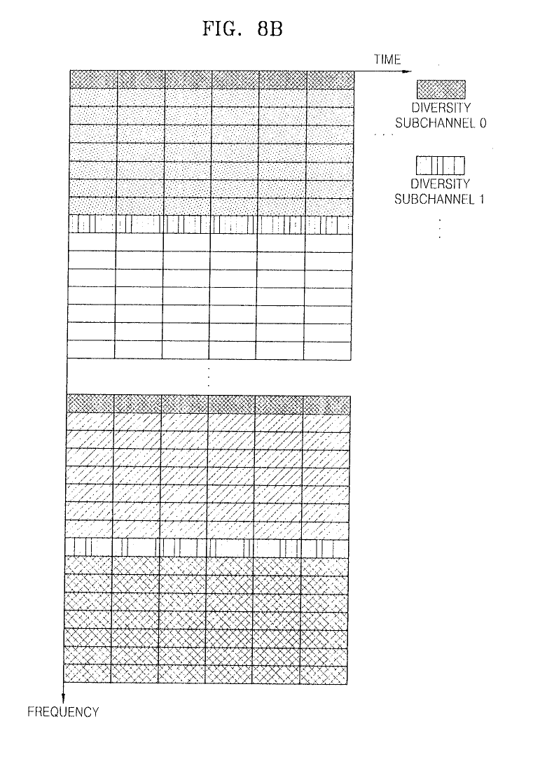

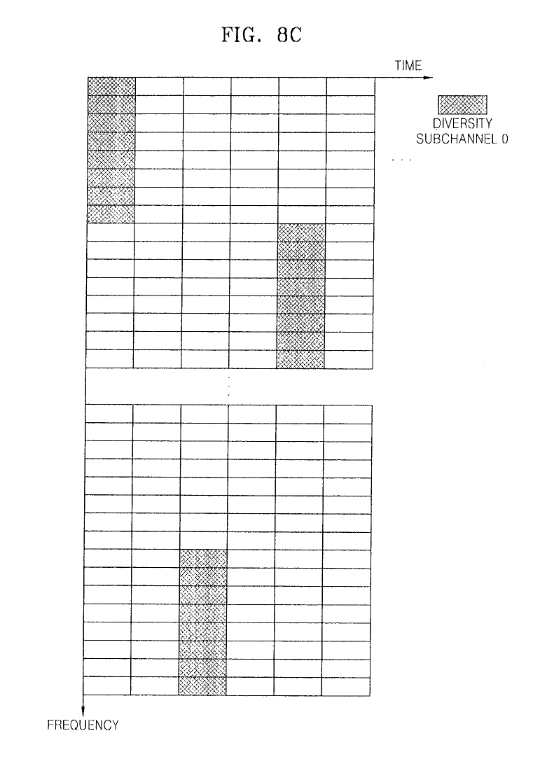

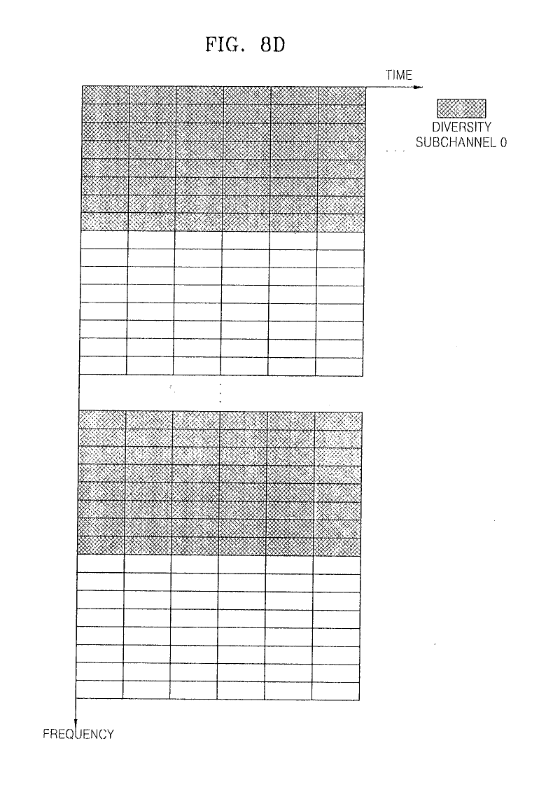

FIGS. 8A through 8D illustrate channel structures used to obtain the graphs illustrated in FIGS. 7A through 7D. In other words, FIGS. 8A through 8D illustrate the distributions of resources forming diversity subchannels according to D and R. The channel structures illustrated in FIGS. 8A through 8D correspond to cases (D=1, R=1), (D=1, R=0), (D=0, R=1), and (D=0, R=0), respectively.

It can be inferred from the performance illustrated in FIGS. 7A through 7D that the highest performance is obtained regardless of the number of resources and the code rate in the case (D=1, R=1) where resources forming diversity subchannels are dispersed in the most various pattern in the time-frequency domain. In addition, when a minimum unit forming a diversity subchannel is a bin comprised of 8 resources, that is, when D=0, performance similar to that obtained when D=1 and R=1 is obtained by setting a different subcarrier start offset for each OFDM symbol, that is, by setting R=1. Accordingly, it can be inferred that when a diversity subchannel is formed in both cases R=0 and R=1, it is preferable to select different subcarriers in the time domain if a small number of subcarriers are allocated to a single OFDM symbol.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer system so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A resource allocation method for an orthogonal frequency division multiplexing access (OFDMA) system, the resource allocation method comprising:
(a) dividing a frequency band occupied by a predetermined number of OFDM symbols into a plurality of subbands and determining the number of diversity subchannels, each of which comprises at least two time-frequency resources respectively included in different subbands, and the number of subband selective subchannels, which comprise time-frequency resources that are not included in the diversity subchannels; and
(b) generating the diversity subchannels and the subband selective subchannels ac cording to the determined numbers and allocating a physical channel comprised of a gene rated subchannel to a user in a cell.

2. The resource allocation method of claim 1, wherein each diversity subchannel comprises time-frequency resources which are included in different OFDM symbols and are located in different positions in a frequency domain.

3. The resource allocation method of claim 1, wherein (a) comprises classifying users in the cell into a first user group, to which a physical channel comprised of a diversity subchannel is allocated, and a second user group, to which a physical channel comprised of a subband selective subchannel is allocated, based on first channel state information of the individual users in the cell.

4. The resource allocation method of claim 3, wherein the first channel state information comprises information about a rate of change of a wireless channel in a time or frequency domain.

5. The resource allocation method of claim 3, wherein (a) comprises classifying the us ers in the cell into the first user group and the second user group based on a grade of each user in the cell.

6. The resource allocation method of claim 1, wherein operation (a) comprises determining the number of diversity subchannels and the number of subband selective subchannels based on an available feedback channel capacity.

7. The resource allocation method of claim 1, further comprising:
periodically repeating (a) and (b) based on first channel state information of each user in the cell in order to reconstruct the physical channel; and
broadcasting information about the reconstruction of the physical channel.

8. The resource allocation method of claim 1, further comprising allocating at least one diversity subchannel to a pilot channel.

9. The resource allocation method of claim 8, further comprising:
periodically reconstructing the diversity subchannel allocated to the pilot channel based on first channel state information of each user in the cell; and
broadcasting information about the reconstruction of the diversity subchannel.

10. The resource allocation method of claim 3, wherein the first channel state information comprises a root mean square (RMS) delay spread value of a forward link channel.

11. The resource allocation method of claim 3, wherein the first channel state information comprises a normalized variance or a normalized standard deviation of a forward link channel.

12. The resource allocation method of claim 3, wherein (b) comprises allocating a physical channel comprised of a subband selective subchannel to a user included in the second user group based on identifiers of a predetermined number of subbands, in which an average signal-to-noise ratio of feedback information from each user included in the second user group is high, and based on values of average signal-to-noise ratios in subbands corresponding to the identifiers.

13. The resource allocation method of claim 1, further comprising determining an adaptive modulation and coding mode for each user based on second channel state information of the physical channel allocated in (b).

14. The resource allocation method of claim 13, wherein the second channel state information comprises an average signal-to-noise ratio of the physical channel.

15. The resource allocation method of claim 1, wherein (b) comprises generating a diversity subchannel in a current cell which does not include time-frequency resources included in a diversity subchannel in an adjacent cell.

16. A computer-readable recording medium for recording a program for executing the method of any one of claims 1 through 15.
